(19) United States
(12) Patent Application Publication
(10) Pub. No.: US 2002/0178375 A1
(43) Pub. Date: Nov. 28, 2002

(54) Method and system for protecting against malicious mobile code

(75) Inventors: James A. Whittaker, West Melbourne, FL (US); Andres De Vivanco, Palm Bay, FL (US); Rahul Chaturvedi, Melbourne, FL (US)

Correspondence Address: IP STRATEGIES, P C, 806 7TH STREET N W SUITE 301, WASHINGOTN, DC, 20001, US

(73) Assignee: Harris Corporation, Melbourne, FL (US)

(21) Appl. No.: 09/952,208

(22) Filed: Sep. 12, 2001

Related U.S. Application Data
(60) Provisional application No. 60/265,364, filed on Jan. 31, 2001.

(51) Int. Cl. G06F 11/30

(52) U.S. Cl. 713/200

(57) ABSTRACT

A host computer including an operating system and at least one local resource controlled thereby is protected from malicious mobile code based upon a protective program stored therein. The protective program identifies mobile code received by the host computer, and modifies the operating system for monitoring access of the local resource by the mobile code. The protective program further includes transferring control of the local resource to the protective program if the mobile code calls the local resource, and determining whether the mobile code is malicious. If the mobile code is malicious, the protective program blocks access to the local resource by the mobile code. If the protective program can not determine if the mobile code is malicious or benign, the mobile code is allowed to execute while changes made to the host system by the mobile code are recorded so that if the user later determines that the mobile code is malicious, the host system can be restored to an initial condition based upon the recorded changes.

### RELATED APPLICATION

This application is based upon prior filed copending provisional application No. 60/265,364 filed Jan. 31, 2001, the entire disclosure of which is incorporated herein by reference.

### FIELD OF THE INVENTION

The present invention relates to the field of computers, and more particularly, to the protection of a host computer receiving executable mobile code that may be malicious.

### BACKGROUND OF THE INVENTION

The use of mobile code is a popular way to stage malicious attacks against computer users. Mobile code is an executable program code that is externally generated with respect to the host computer. A host computer 10 may receive two types of mobile code 12: script 12a and native code 12b, as illustrated in FIG. 1. Script 12a requires a scripting host 14 for the code to interface with various application programs within the application level 16 of the host computer 10. Application programs include Microsoft's Winword 18a and Outlook 18b, for example.

Access or calls to the operating system 20 by the script 12a is accomplished via function dispatchers 22. Function dispatchers 22 keep track of the memory addresses for the application programs 18a, 18b as they are loaded within the host computer 10. In contrast, native code 12b may bypass the application programs 18a, 18b and access the operating system 20 directly or through the function dispatchers 22, as illustrated in FIG. 1.

The Windows operating system is often the target of such malicious attacks, in part because of its ubiquity and in part because of the vast functionality it provides. Some of this functionality, like executable e-mail attachments and scripting, provides opportunity for mobile code 12 to cause significant damage to the host computer 10. One approach is to disable such features in Windows. However, this results in a loss of functionality, and many users find such features a convenient and productive way to conduct their business.

One example of a damaging computer virus is the ILOVEYOU virus, which was sent via e-mail on May 4, 2000, from the Philippines. The ILOVEYOU virus wreaked havoc on an estimated forty five million computers all over the world, causing a record 80 million dollars in damage. The virus copied its propagation technique from the infamous Melissa virus, by reading user's e-mail address books and sending itself to everyone listed.

The ILOVEYOU virus' method of doing damage made it the most costly virus in history. Not only did the ILOVEYOU virus damage crucial system files, it also made copies of itself, masquerading as picture, sound and script files to be repeatedly executed by hapless users. The ILOVEYOU virus underscores the vulnerabilities that exist in the Windows operating system.

Windows itself is built for maximum functionality and backward compatibility. Indeed, its vast list of functionality is often cited as the reason for its market dominance. The need for backward compatibility, i.e., the ability for old programs to execute under new Windows versions, is so acute that in its recent release, Microsoft instituted a certification program for third-party vendors to ensure that their applications work properly.

The drive for maximum functionality and backward compatibility has often been at odds with security. System application program interfaces (APIs) cannot be rewritten to provide greater security without breaking existing programs that are using them. Once such programs cease to work, users will likely turn off any type of protection, or decide not to upgrade, in favor of being able to use the programs that they rely on to get their work done.

One approach for protecting a host computer from malicious mobile code is known as code signing or signature-based protection. Signature-based protection requires software developers to obtain certificates of authenticity in order for their application to run. Obtaining such a certificate may be impossible for some older software, and cost-prohibitive for small development organizations. This approach for protecting a host computer from malicious mobile code is reactive, and is only effective at the perimeter of the host computer, i.e., at the mobile code level.

Another approach for protecting a host computer from malicious mobile code is done at the application level. This approach is proactive, and is also known as sandbox-based protection because the protection wraps or hooks all mobile code to prevent malicious calls to the operating system.

An example of virus protection at the application level is disclosed in U.S. Pat. No. 6,167,520 to Touboul. More commonly known as Finjan software, the '520 patent discloses the use of probes at the application level for intercepting mobile code before it gets to the operating system. Unfortunately, too many applications, i.e., targets, get hooked at the application level. In addition, the probes are running all the time regardless of whether the computer receives any mobile code. This results in a performance degradation of the host computer because of the extra processing.

Yet another disadvantage of detecting malicious mobile code at the application level, as illustrated in the '520 patent, is that access by the mobile code to the operating system is still possible via what is commonly known by one skilled in the art as a “backdoor.” In other words, native code could be written to directly access the operating system by bypassing the application level, as illustrated in FIG. 1. Yet another disadvantage of the prior art approaches is that if a host computer executes a mobile code that is malicious, the host computer can not be restored to it initial configuration without losing critical user date.

Techniques that proactively stop malicious code but do not reduce functionality or break existing programs are needed. However, there is a marked absence of such techniques in the technical literature or in commercial tools. The techniques that have been reported, such as signature-based protection and sandbox-based protection fall short of fully protecting critical system components against arbitrary mobile code. Either a subset of system components are protected, or only certain types of mobile code can be monitored.

### SUMMARY OF THE INVENTION

In view of the foregoing background, it is therefore an object of the present invention to provide a method for proactively stopping malicious mobile code received by a host computer without reducing functionality thereof.

Another object of the present invention is to restore a host computer to an initial condition if malicious mobile code is executed by the host computer.

These and other objects, features and advantages in accordance with the present invention are provided by a method for protecting a host computer from malicious mobile code, with the host computer including an operating system and at least one local resource controlled thereby. The method preferably comprises identifying mobile code received by the host computer, and modifying the operating system for monitoring access of the at least one local resource by the mobile code. Control of the at least one local resource is preferably transferred to a protective program if the mobile code calls the at least one local resource, and the method further comprises determining whether the mobile code is malicious.

The method according to the present invention advantageously detects mobile code at the operating system level. Since detection of mobile code at the application level can be bypassed with native code, for example, the protection program of the present invention is within the operating system itself waiting for the mobile code to access any of the local resources within the host computer.

In other words, mobile code is allowed to access the operating system in the present invention, whereas the prior art approaches intercept the mobile before accessing the operating system. In the present invention, to determine if the mobile code calls the at least one local resource, the method preferably further comprises inserting at least one jump command within the operating system for transferring control of the at least one local resource to the protective program. The method thus further comprises transferring control of the at least one local resource to the protective program via the jump command if the mobile code calls the at least one local resource. Consequently, when the host computer receives the mobile code, the first statement actually executed in the operating system is the jump command, which transfers control of the local resource to the protective program.

Inserting the jump command within the operating system may be performed on-the-fly, i.e., automatically, using a code replacement algorithm, wherein the code replacement algorithm may be coded in assembly language. The code replacement algorithm may modify machine language instructions within the host computer.

If the protective program determines that the mobile code is malicious, then the protective program blocks access to the at least one local resource by the mobile code. Blocking access to the at least one local resource may be performed without user input, that is, automatically in response to the protective program determining that the mobile code is malicious. To determine that the mobile code is malicious, the method may further comprise comparing a function of the at least one local resource to be accessed by the mobile code to a list of prohibited functions. The list of prohibited functions may include, for example, at least one of operating system functions, file functions, registry functions, library functions, communication functions and network functions.

If the protective program determines that the mobile code is not malicious, then the protective program transfers control of the at least one local resource back to the mobile code. This may be done without receiving any input form the user.

However, if the protective program determines that a function of the at least one local resource to be accessed by the mobile code is potentially malicious, i.e., the protective program is not able to determine if the mobile code is malicious or benign, then the method may further comprise requesting user input before transferring control of the at least one local resource back to the mobile code. If the user decides to execute the mobile code, the method may further comprise recording changes made to the host computer by the mobile code. This advantageously allows the user to restore the host computer to an initial condition based upon the recorded changes if the user later determines that the potentially malicious mobile code is malicious.

Alternatively, the user may not be prompted if the mobile code is potentially malicious, and control of the at least one local resource is transferred back to the mobile code as above, and the changes made to the host computer by the mobile code are also recorded. Likewise, if the user later determines that the potentially malicious mobile code is malicious, then the user can restore the host computer to an initial condition based upon the recorded changes.

Another aspect of the present invention is to use a quarantine computer connected to, but separate, from the host computer to execute potentially malicious mobile code. The quarantine computer also includes the protection program, but does not need to include any user data that may be lost or damaged from a malicious mobile code.

Yet another aspect of the present invention is directed to a machine readable medium having machine readable instructions stored thereon for causing a host computer to perform the steps of identifying mobile code received by the host computer, modifying an operating system of the host computer for monitoring access of the at least one local resource by the mobile code, transferring control of at least one local resource within the host computer to a protective program if the mobile code calls the at least one local resource, and determining whether the mobile code is malicious. Another embodiment of the computer readable medium is directed to a protective program that determines whether the mobile code is potentially malicious.

A further aspect of the present invention is directed to a computer system comprising a processor having an operating system associated therewith, at least one local resource controlled by the operating system, and a memory connected to the processor and having stored therein a protective program as described above for protecting the at least one local resource from a malicious mobile code. Another embodiment of the computer system is directed to a protective program that determines whether the mobile code is potentially malicious.

### BRIEF DESCRIPTION OF THE DRAWINGS

FIG. 1 is a block diagram illustrating various software levels within a host computer according to the prior art, with the software levels including mobile code, the application level and the operating system.

FIG. 2 is a block diagram of a stand-alone host computer connected to the Internet, with the host computer including the protective program in accordance with the present invention.

FIG. 3 is a block diagram of a local area network (LAN) connected to the Internet, with the LAN including the host computer illustrated in FIG. 2.

FIGS. 4-8 illustrate screen snapshots based upon the protective program detecting the ILOVEYOU virus in accordance with the present invention.

FIGS. 9-11 illustrate screen snapshots based upon the protective program detecting the Melissa virus in accordance with the present invention.

FIGS. 12-15 illustrate screen snapshots based upon the protective program detecting the PrettyPark virus in accordance with the present invention.

FIGS. 16 and 17 respectively illustrate screen snapshots of two common downloads: CdrWin and Napster without user intervention based upon the protective program in accordance with the present invention.

FIG. 18 is a flowchart illustrating a method for protecting a host computer from a malicious mobile code in accordance with the present invention.

FIG. 19 is a flowchart illustrating a method for protecting a host computer from a potentially malicious mobile code in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. The dimensions of layers and regions may be exaggerated in the figures for greater clarity.

The present invention is effective at neutralizing malicious mobile code received by a host computer. Mobile code may enter a host computer through network-enabled components or through external storage devices. To protect the host computer from a malicious mobile code, a protective program is stored within memory of the host computer. The protective program will also be referred to herein as the IMP tool. The acronym IMP stands for identifying, monitoring and protecting. Identifying, monitoring and protecting are the three main stages or tasks performed for stopping malicious mobile code received by the host computer.

A first stage of operation includes identifying and runtime monitoring of processes that are spawned by mobile code. A second stage of operation is that once a suspect process has been identified, the process is contained, i.e., keep it from spawning new, unmonitored processes, and its behavior is continually monitored. A third stage of operation includes reacting to suspect behaviors by blocking, quarantining or tracking the target process so that damage can be prevented or undone.

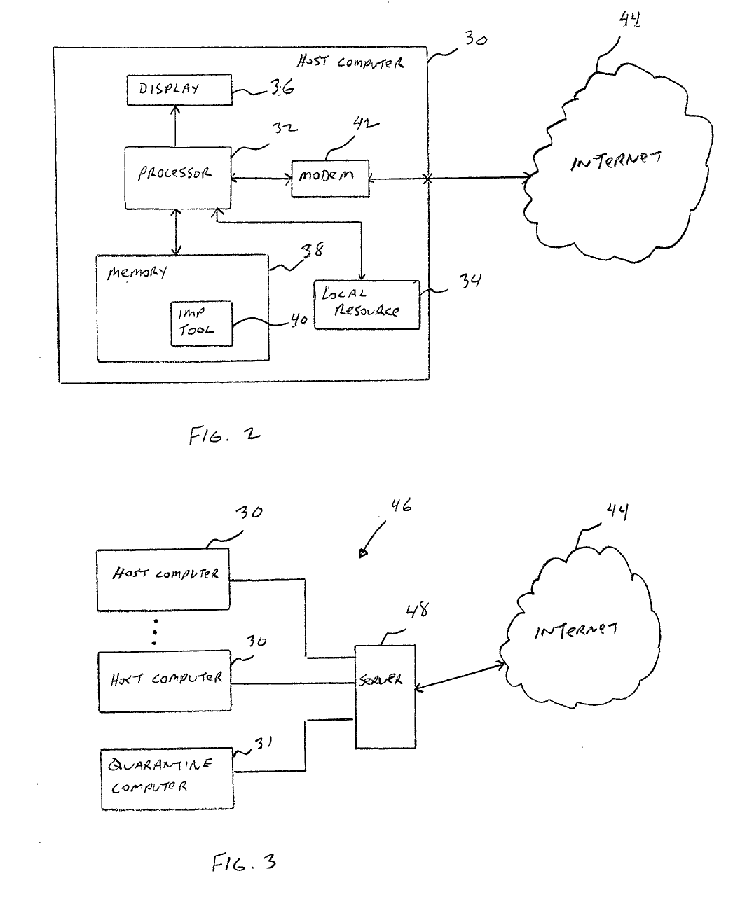

Referring now to FIGS. 2 and 3, the host computer 30 includes a processor 32 having an operating system associated therewith, and at least one local resource 34 controlled by the operating system. The at least one local resource 34 may be a hard drive, a floppy drive, a CD drive, or a zip drive, for example.

A display 36 is connected to the processor 32, and a memory 38 is connected to the processor for storing therein the protective program or IMP tool 38 for protecting the at least one local resource 34 from a malicious mobile code. The memory 38 may be separate from the processor 32 as illustrated in FIG. 2, or may be embedded therein.

A modem 42 and a corresponding communications driver interfaces the host computer 30 to the Internet 44, as illustrated in FIG. 2. The present invention is also applicable to a plurality of host computers 30 connected together to define a local area network (LAN) 46, which is also connected to the Internet 44, as illustrated in FIG. 3. Each host computer 30 is connected to the Internet via a server 48, and each host computer includes an Ethernet or similar hardware card instead of a modem 42. The host computer 30 thus receives mobile code via network-enabled components (e.g., the modem 42 or the Ethernet card), or through external storage devices (e.g., a floppy drive, a CD drive, or a zip drive) including mapped hard drives as may be the case for a host computer 30 connected to the LAN 46.

Discussion of the IMP tool 40 is directed to the Windows operating system, however, this is for illustration purposes and the present invention is applicable to other operating systems, as readily appreciated by one skilled in the art. The IMP tool 40 protects all major Windows components including the registry, file system, scripting host, system APIs, communication APIs, etc., from arbitrary mobile code. Arbitrary mobile code includes exploits written in scripting languages like Java Script or Visual Basic Script and system languages like C or native Win32.

The IMP tool 40 identifies mobile code 12, monitors the mobile code, and protects the host computer 30 from the mobile code if it is determined that the code is malicious. Malicious mobile code includes viruses, such as the ILOVEYOU virus, worms and Trojans.

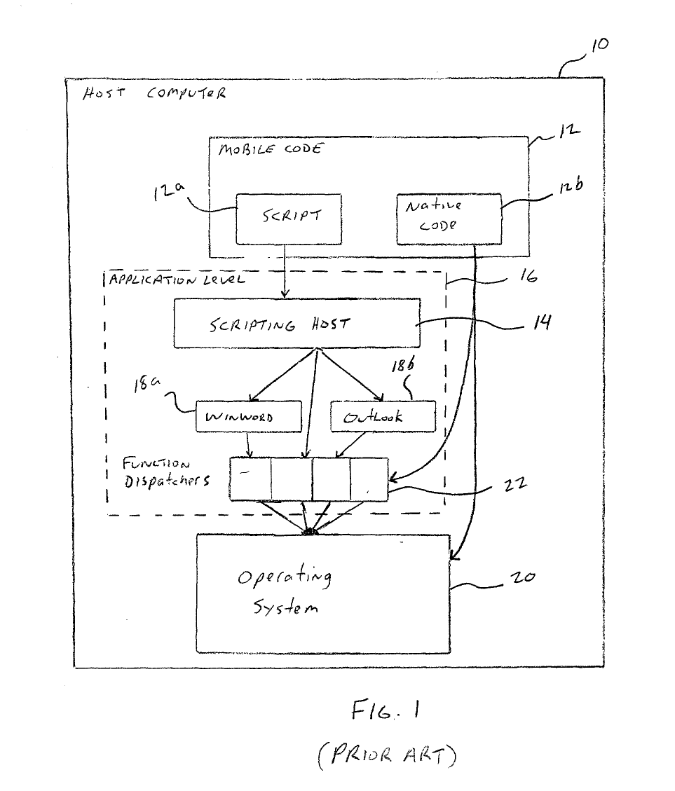

The first stage of the IMP tool 40 for protecting a host computer 30 from a malicious mobile code is to identify the mobile code 12. Mobile code 12 may be script 12a or native code 12b, as discussed in the background section of the invention and as illustrated in FIG. 1. Any interface of the host computer 30 that imports mobile code through network-enabled components or through external storage devices could potentially be the carrier of a virus. Thus, each executable program or reusable program component must be scanned for its access to external resources. Any such component must be considered a potential security concern.

If one is only interested in particular applications such as web browsers and e-mail programs, then one can simply watch for programs such as IEXPLORE.EXE loading and intercept calls made by them to create files, create processes or load library functions. Thus, a protected browser or a protected e-mail client, that is, one that cannot launch undetected processes, can be created.

The IMP tool 40 monitors all processes spawned on the host computer 30, which may also be referred to as the protected machine, and identifies OUTLOOK.EXE and IEXPLORE.EXE automatically when they are launched. Furthermore, if the IMP tool 40 is launched after these programs, it will hook the running process of either program and proceed to monitor their behavior, as will be discussed in greater detail below with respect to the monitoring stage of the IMP tool 40.

The IMP tool 40 can hook arbitrary processes but requires certain processes to be identified by the user. For example, Outlook, Outlook Express and Internet Explorer may be hooked automatically. However, new programs can be added to the IMP tool's 40 list of programs to automatically identify.

The IMP tool 40 may also hook EXPLORER.EXE as the program to copy files from floppy drives, CD-ROM drives, ZIP drives, and mapped network drives. The user must identify other drive portals to the IMP tool 40, and once done, the IMP tool will automatically monitor these as well.

Once the IMP tool 40 has identified a program as having foreign origins, its use of local system resources 34 is carefully controlled. For example, the following Windows components are monitored for malicious use.

The Windows Scripting Host is a COM interface that is used by common virus targets such as Word to run macro programs written in Visual Basic Script. Such macros make up the majority of Windows viruses. Mobile code which run macros are highly suspect and requires close scrutiny.

The Network Port can be accessed through network-enabled programs such as Outlook and through APIs, such as MAPI. Detecting propagation through known network portals is fairly straightforward. Indeed, the IMP tool 40 can detect use of socket APIs and prevent propagation through them. The only alternative for virus writers would be to include their own socket driver inside the virus itself, a fairly unlikely scenario.

Memory and System Calls must also be tracked to prevent a mobile program from launching a separate process to avoid scrutiny, i.e., jumping out of the sandbox, as readily understood by one skilled in the art. Alternatively, calls that load other programs must also be intercepted to prevent mobile code 12 from using existing executables to perpetrate damage. For example, a library like MSO9.DLL has access to the file system and local kernel resources. If a mobile code 12 loads this or any other utility library, the IMP tool 40 must be aware that a foreign program is controlling a local resource 34.

The Registry is obviously a source of concern since it can be used to control application behavior and can affect overall system stability. Certain registry keys should only be modified by Windows itself. Other registry keys belong to specific applications and still others control user preferences and setup information. The IMP tool 40 will not allow a mobile program to change the registry without intervention, as will be discussed in greater detail below with respect to the protection stage of the IMP tool 40.

The File System is where Windows stores persistent system data and users save their working files. A common mobile code exploit is to delete or modify key files to disable Windows or maliciously delete user files. The IMP tool 40 proactively protects the Windows operating system by preventing file writes to system directories or allowing modification of any file in the boot path.

Applications also store important files that should not be tampered with by mobile code 12. The infamous Melissa virus made its mark by infecting the Word template NORMAL.DOT. The net effect is that once infected, Word then caused every file that was created or modified thereafter to be infected as well. The IMP tool 40 protects Word, for example, as well as other registered applications.

The second stage of the IMP tool 40 for protecting a host computer 30 from a malicious mobile code is to monitor the mobile code 12. Monitoring the mobile code 12 can be accomplished using either import address table (IAT) replacement or code replacement.

Using the import address table (IAT) replacement, a program's IAT is created by the compiler/linker and used by the operating system to establish imported interfaces. Reading and replacing a program's IAT in memory is a common method of API hooking. Since all calls are intercepted in memory 38, IAT replacement is faster than another approach referred to as binary redirection. The replacement IAT sends calls to imposter functions that have blocking or pass-through capability. This technique is well known by one skilled in the art.

The downside of the IAT replacement approach, as well as the binary approach and yet another approach known as the re-linking dynamically loadable modules approach, is that these approaches can be bypassed in a very straightforward manner. Since they work on published interfaces, a malicious program could make direct jumps to other processes so that control flow is changed without the knowledge of the monitor program. Once such a jump is made, interrogation of the mobile code 12 is no longer possible.

Consequently, the preferred approach for monitoring malicious mobile code is code replacement. Code replacement is the preferred way to protect against sophisticated viruses written in system languages such as C. C programs can directly access memory 38. Clever programmers can use this capability to cause foreign instructions to be executed without external calls being made.

By overwriting the first few bytes of a function header, the IMP tool 40 can place its own unique function identifiers and assess exactly what function is executing, and whether it is one that should be interrogated. In particular, the protective program 40 inserts at least one jump command within the at least one local resource for monitoring the mobile code 12, wherein each jump command is for transferring control of the at least one local resource 34 to the protective program. If the mobile code calls the at least one local resource 34, then control of the at least one local resource is transferred to the protective program 40 responsive to the jump command.

A list of functions within the operating system 20 that a mobile code 12 can do damage through for accessing the local resources 34 is provided below in Table 1. In other words, when mobile code 12 is identified as being received by the host computer 30, the protective program 40 places jump commands corresponding to these critical functions. If the mobile code 12 calls a local resource associated with anyone of these functions, then control of the local resource 34 is transferred to the protective program 40 via the respective jump commands.

Critical functions that are monitored within the operating system 20 for determining when mobile code 12 is accessing the local resources 34 of the host computer 30.

TABLE 1

Secure_CopyFileA
Secure_CopyFileW
Secure_CopyFileExA
Secure_CopyFileExW
Secure_CreateDirectoryA
Secure_CreateDirectoryW
Secure_CreateDirectoryExA
Secure_CreateDirectoryExW
Secure_CreateFileA
Secure_CreateFileW
Secure_DeleteFileA
Secure_DeleteFileW
Secure_MoveFileA
Secure_MoveFileW
Secure_MoveFileExA
Secure_MoveFileExW
Secure_MoveFileWithProgressA
Secure_MoveFileWithProgressW
Secure_RegCreateKeyA
Secure_RegCreateKeyW
Secure_RegCreateKeyExA
Secure_RegCreateKeyExW
Secure_RegOpenKeyA
Secure_RegOpenKeyW
Secure_RegOpenKeyExA
Secure_RegOpenKeyExW
Secure_RegSetValueExA
Secure_RegSetValueExW
Secure_RegDeleteKeyA
Secure_RegDeleteKeyW
Secure_RegDeleteValueA
Secure_RegDeleteValueW
Secure_RegSetValueA
Secure_RegSetValueW
Secure_RegSetValueExA
Secure_RegSetValueExW
Secure_RegEnumKeyA
Secure_RegEnumKeyW
Secure_RegEnumKeyExA
Secure_RegEnumKeyExW
Secure_SHDeleteEmptyKeyA
Secure_SHDeleteKeyA
Secure_SHDeleteValueA
Secure_SHDeleteEmptyKeyW
Secure_SHDeleteKeyW
Secure_SHDeleteValueW
Secure_CoCreateInstanceEx
Secure_CoGetClassObject
Secure_CoRegisterClassObject
Secure_CreateProcessA
Secure_CreateProcessW
Secure_GetProcAddress
Secure_LoadLibraryExA
Secure_LoadLibraryExW
Secure_LoadLibraryA
Secure_LoadLibraryW
Secure_RpcNetworkIsProtseqValidA
Secure_RpcNetworkIsProtseqValidW
Secure_RpcNsBindingExportA
Secure_RpcNsBindingExportW
Secure_RpcServerRegisterAuthInfoA
Secure_RpcServerRegisterAuthInfoW
Secure_RpcServerListen
Secure_UuidCreate
Secure_UuidToStringW
Secure_UuidToStringA
Secure_RpcStringFreeA
Secure_RpcStringFreeW
Secure_RpcBindingFree
Secure_RpcServerRegisterIfEx
Secure_RpcImpersonateClient
Secure_RpcEpResolveBinding
Secure_RpcStringBindingComposeA
Secure_RpcStringBindingComposeW
Secure_RpcBindingToStringBindingW
Secure_RpcBindingToStringBindingA
Secure_RpcBindingSetAuthInfoW
Secure_RpcBindingSetAuthInfoA
Secure_RpcBindingFromStringBindingA
Secure_RpcBindingFromStringBindingW
Secure_RpcServeruseProtseqEpExA
Secure_RpcServerUseProtseqEpExW
Secure_RpcStringBindingParseA
Secure_RpcStringBindingParseW
Secure_RpcServerUnregisterIf
Secure_accept
Secure_connect
Secure_listen
Secure_recv
Secure_TransmitFileWS2
Secure_WSARecv
Secure_WSASend
Secure_send
Secure_InternetOpenA
Secure_InternetOpenW
Secure_FtpPutFileA
Secure_FtpPutFileW
Secure_ReadProcessMemory
Secure_WriteProcessMemory
Secure_Netbios

Code replacement algorithms are preferably coded in assembly language and require on-the-fly modification of machine language instructions as they are executing. Code replacement provides an extremely effective interrogation mechanism. Indeed, it puts virus writing beyond the capability of the average programmer and into the hands of only the most skilled programmers. The IMP tool 40 is preferably built on a code replacement engine, but also employs the IAT replacement approach when appropriate.

The third stage of the IMP tool 40 is to protect the host computer 30 infected with a malicious mobile code. During the monitoring process, the IMP tool 40 must make judgement calls about which functions to allow to go through, which functions to block, and which functions are questionable enough (i.e., potentially malicious) to obtain further instruction. Further instruction may be provided either from the user or some third-party policy provider. Obviously, such decision-making is important and carries with it the risk of making the wrong decision.

There are two types of wrong decisions: false negatives and false positives. A false negative occurs when a malicious behavior is incorrectly deemed benign and allowed to pass through the IMP tool's 40 defenses. There are several ways in which false negatives can occur. One way is that the rules the IMP tool 40 applies to categorize malicious vs. benign behavior are flawed or incomplete. These rules are discussed below.

Another way is that some clever virus writer figures out a way to cause damage by using an otherwise benign combination of system calls. The idea is that each call taken on an individual basis is acceptable, but that the combination of calls allows damage to occur. Finally, as with any software, it is always possible that bugs in the IMP tool's 40 implementation could render it vulnerable in specific attack scenarios.

The IMP tool 40 has a hard-coded set of “known bad functions”, (i.e., malicious functions) that no mobile code should be allowed to do. For example, specific registry keys are off limits, reformatting the hard drive is not allowed, and modification of the kernel is prevented, among other things. There are a number of such behaviors that are guarded against and will always be prevented when detected by the IMP tool 40.

However, the list of “questionable functions,” that is, behaviors that might cause damage but also might be part of a legitimate operation require more sophisticated pattern analysis. Referring now to false positives, a false positive occurs when a benign behavior is incorrectly identified as malicious. False positives are unavoidable. Installation programs downloaded from the Internet 44 will look very much like malicious code because they will read and write files, change registry settings, and perhaps insert themselves in the boot path. The main danger concerning false positives is that they annoy users. Annoyed users will often turn off protective software when false positives begin to hinder productivity.

One approach for minimizing false positives is to limit the scope of protection to only the list of “known bad functions.” For example, we might decide that a script 12a which sends e-mail to every person in an Outlook address book is always a bad idea. Stopping such a behavior is easily within the IMP tool's 40 capability and false positives would be few and far between. Indeed, the freeware tool called “Just Be Friends” does exactly that: stops propagation through Outlook and nothing else. Commercial tools from Finjan, Aladdin, Pelican, Computer Associates and InDefense also protect against a limited subset of system calls, essentially their own list of “known bad things.” Thus, false positives are reduced but so is protection.

The IMP tool's 40 approach is different and is based on the list of “known bad functions” and “questionable functions” as discussed above. Known bad functions are stopped and the two, user-selectable modes of the IMP tool 40 govern the handling of questionable functions.

In manual mode, the IMP tool 40 prompts the user for direction for each questionable behavior. Alternatively, an external policy provider such as a system administrator, could serve such a function, thus taking the user completely out of the loop.

It is possible that during the manual mode operation, a user could make unwise choices. The IMP tool 40 attempts to provide accurate and clear information to the user and to double check every potentially harmful decision. However, users are unpredictable. To guard users against their own poor or uninformed choices, the IMP tool 40 implements a backup procedure for each call that a user allows to go through. Thus, if the user finds out after-the-fact that they allowed a virus to execute, they can use the IMP tool's 40 built-in backup feature to undo the damage caused by the virus, and automatically restore any data or system changes that were lost.

In the automatic mode, the IMP tool 40 allows every call to go through but retains a record of the system changes made by the call and creates backups of all registry and file system changes. This is a novel approach to false positive mitigation because the user does not get any false positive prompts. Instead, every call goes through as if the program were benign. In the event that the mobile code program is later identified as malicious, an auto-restore is generated based on the backup data saved by the IMP tool 40.

With the IMP tool's 40 auto-restore feature, the idea is to allow all mobile programs to freely execute, but save every change they make to the local resources 34 within the host computer 30 so that any damage they may do can be automatically and completely undone. The exception to this rule is that any undoable change, such as a complete disk reformat, writing to protected memory or propagation, generates a prompt as though the IMP tool 40 were in the manual mode.

Another aspect of the present invention is to use a quarantine computer 31, as illustrated in FIG. 1 that is connected to, but separate, from the host computer 30 to execute questionable mobile code. The quarantine computer 31 also includes the protection program 40, but does not need to include any user data that may be lost or damaged from a malicious mobile code.

The effectiveness of the IMP tool 40 against several noted viruses will now been discussed. The first virus is known as the “love worm” or the “love bug.” The love bug came as an e-mail with the flattering subject line ILOVEYOU and the message “kindly check the attached love letter for you.” However, the attachment was actually the Visual Basic script LOVE.VBS and its intentions were anything but romantic.

LOVE.VBS had three main targets: user files, system files and the Windows registry. It masqueraded as picture (.JPG), sound (.MP3) and script (.VBS) user files by deleting the original files and copying itself under the original filename. Thus, not only did the worm execute from Outlook, it ran again when the user tried to open one of the infected files from Explorer. In addition, it infiltrated the system directory and used a combination of the registry and its location in the system directory to ensure that it executed at boot time.

By all accounts this is a malicious and determined worm. However, its behavior is easy to catch using call interception. The worm makes no attempt at subterfuge at the system call level. All its actions are blatantly malicious.

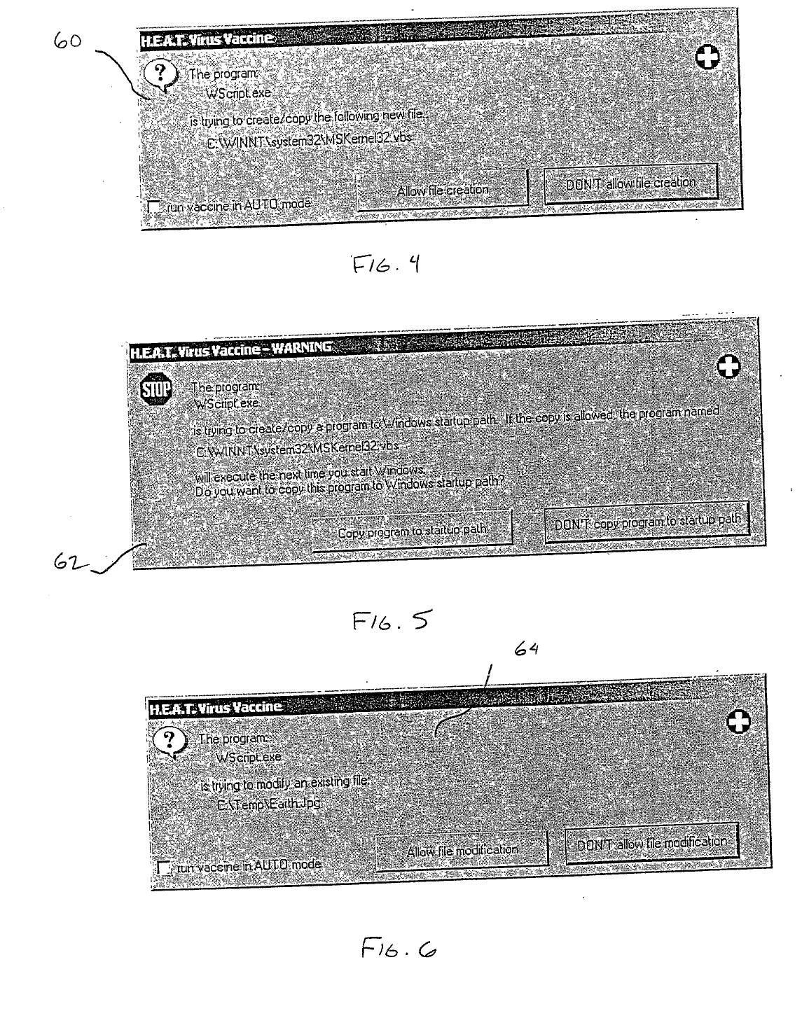

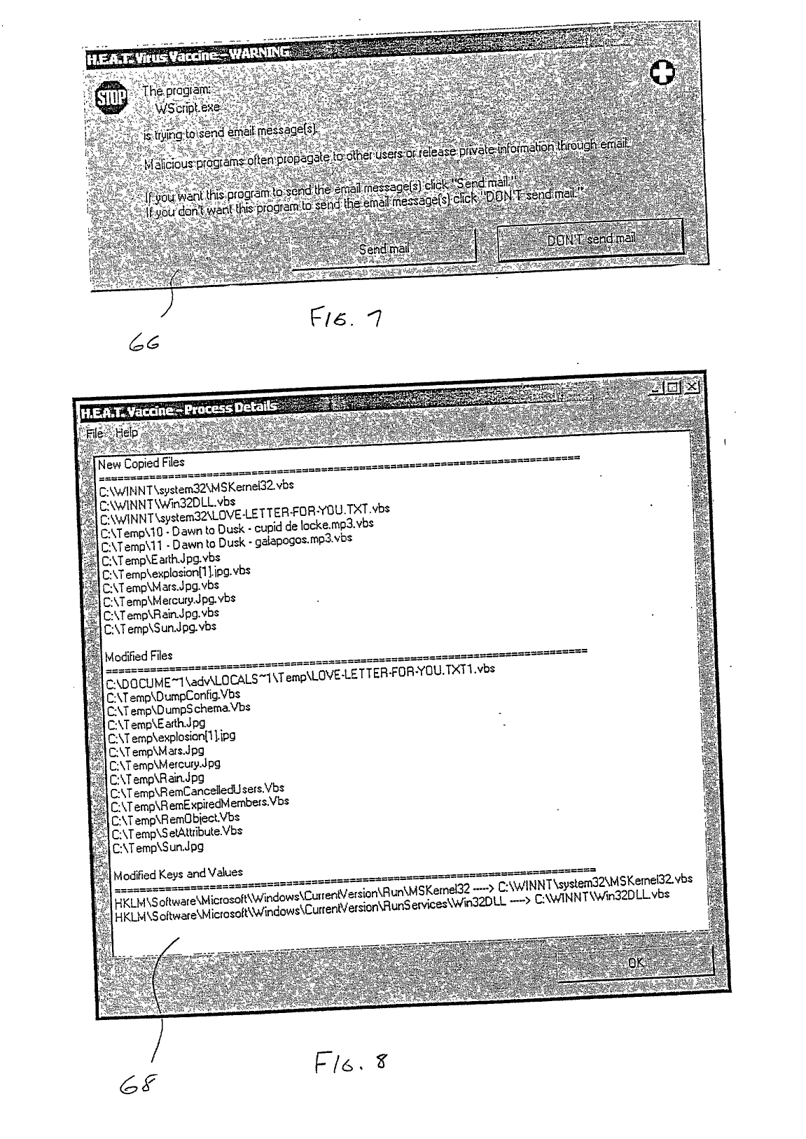

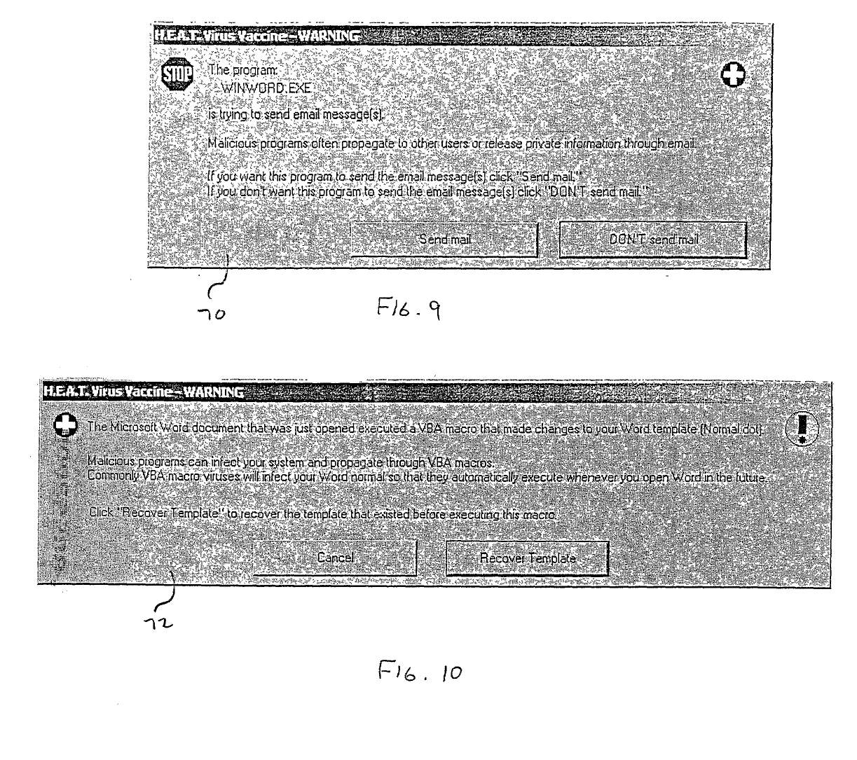

Referring now to FIGS. 4-6, these figures respectively shows three different screen snapshots 60, 64 and 66 based upon the IMP tool 40 stopping the love worm attempting each of its three categories of exploits. The number of such dialogs that a user will receive via the display 36 depends on the number of picture, sound and scripts files they have on their computer. The dialogs appear only when the IMP tool 40 is set to the manual mode.

Screen snapshot 60 notifies the user that the ILOVEYOU virus attempts to copy itself to the system directory. Screen snapshot 62 notifies the user that the ILOVEYOU virus is modifying a special registry key to ensure that the virus runs again if the user restarts the host computer 30. Screen snapshot 64 notifies the user that the ILOVEYOU virus is destroying image files (BMP, JPEG, etc.) and other user files.

In the automatic mode, the user will see only one dialog, that dealing with propagation. Since all of the file changes are undoable, the IMP tool 40 will quietly backup all user and system files and registry entries and allow the virus to run its course. However, propagation is not undoable and therefore elicits a warning to the user as shown by screen snapshot 66 in FIG. 7.

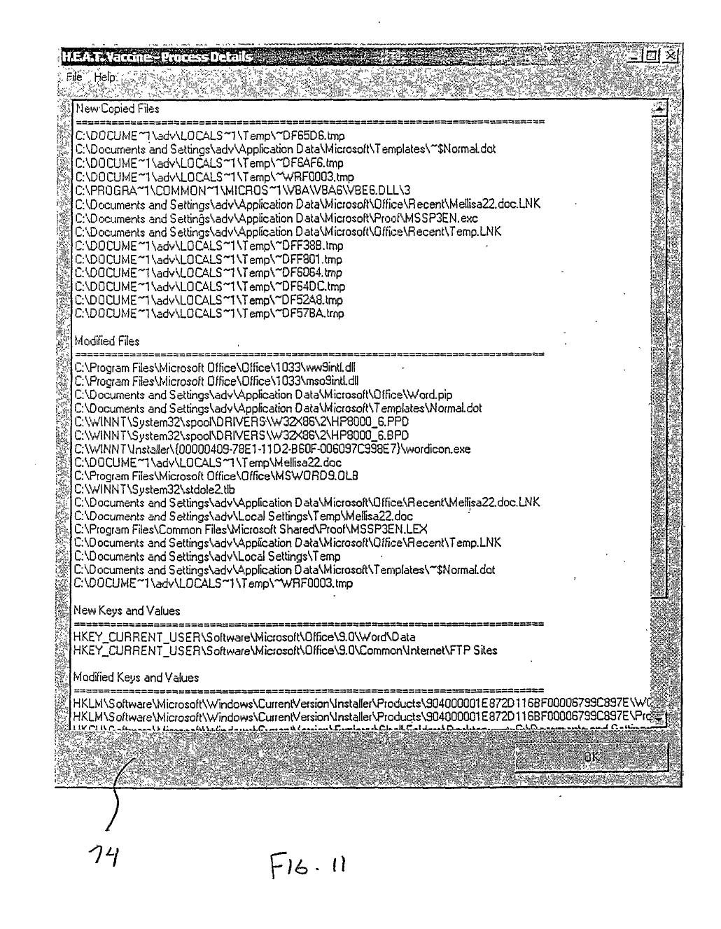

Also shown in screen snapshot 68 illustrated in FIG. 8 is the IMP tool's log 40 of the virus' activity. Not only does this log provide valuable detailed behavioral analysis to form a virus signature for traditional anti-virus applications, it also serves as a record of all information that must be restored when the user presses the IMP tool's 40 undo button.

A second virus is known as the Melissa virus, and infects existing files and propagates both through the creation of new documents and through the traditional Outlook vulnerability. Obviously, the latter propagation technique is easy to catch. However, since Melissa attacks Word documents and Word templates, protection must stretch to include WINWORD.EXE and its associated file structure.

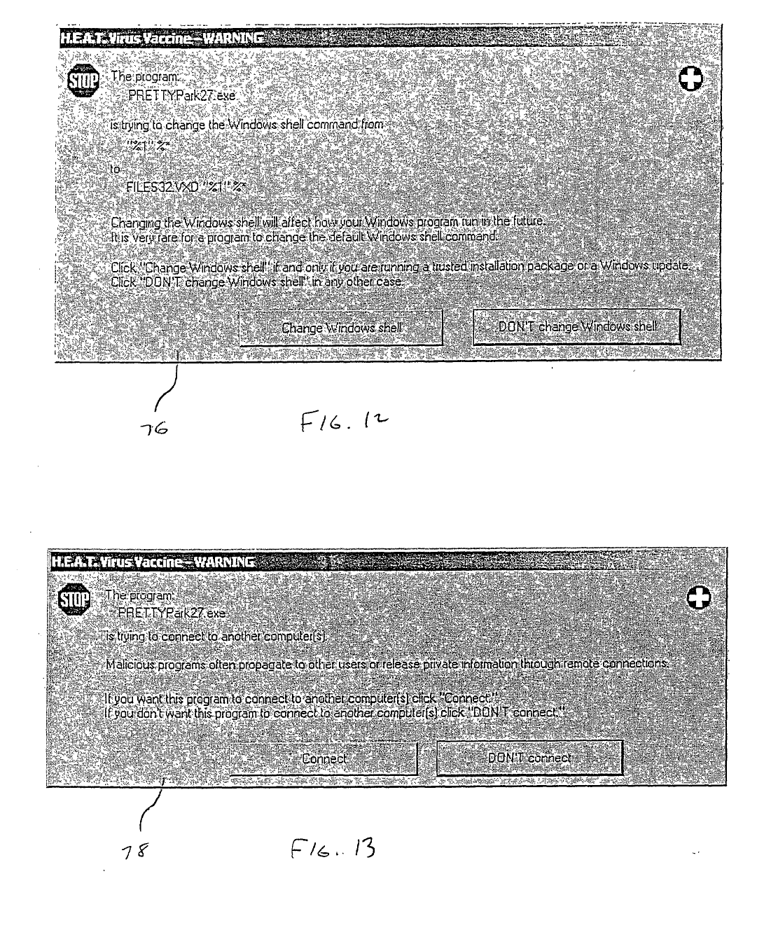

The IMP tool 40 does just that. It intercepts usage of Word resource and user files and denies modification via mobile code 12. Screen snapshot 70 in FIG. 9 shows the result of the Melissa virus when the IMP tool 40 is in manual mode, and Screen snapshots 72, 74 in FIGS. 10 and 11 shows the IMP tool's automatic mode log and its intervention when Melissa tries to propagate through Outlook.

Finally, a third virus tested against the IMP tool 40 is known as PrettyPark. PrettyPark is a malicious hoax that took advantage of the popularity of the television show South Park. In many ways, PrettyPark is no different than the love worm in that it deletes files, copies itself into the system directory, changes registry settings and propagates through Outlook. However, PrettyPark does this through native Win32 calls instead of via the Windows Scripting Host. PrettyPark is thus a compiled executable.

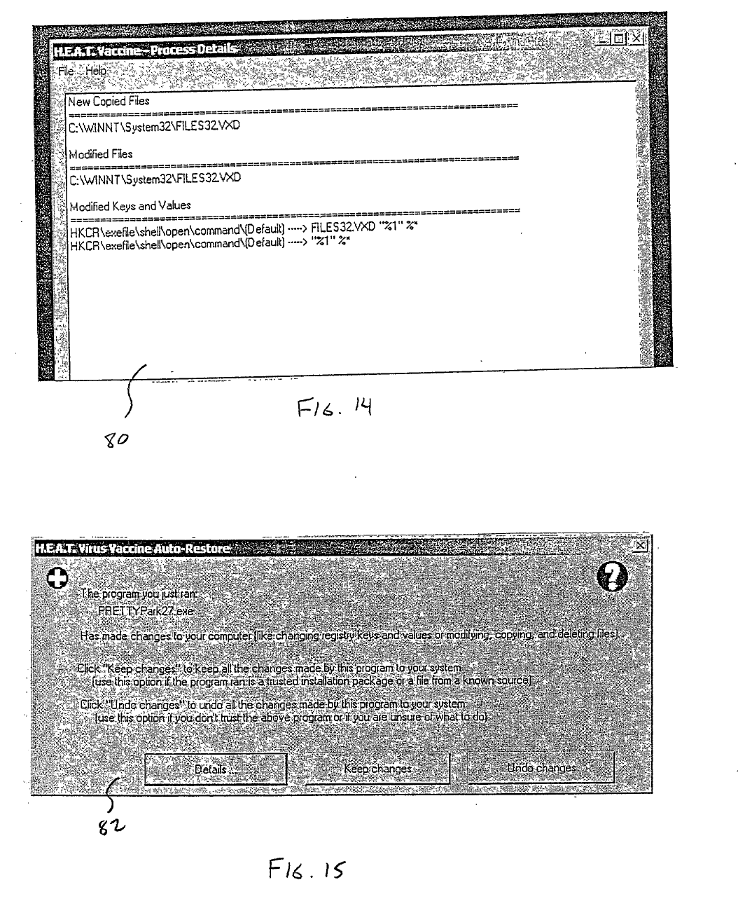

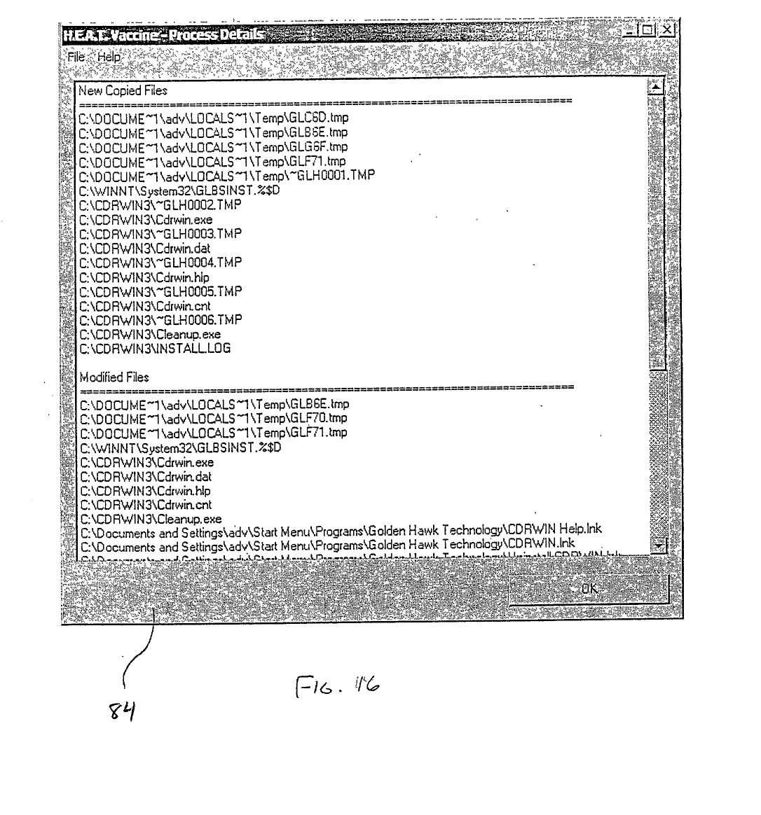

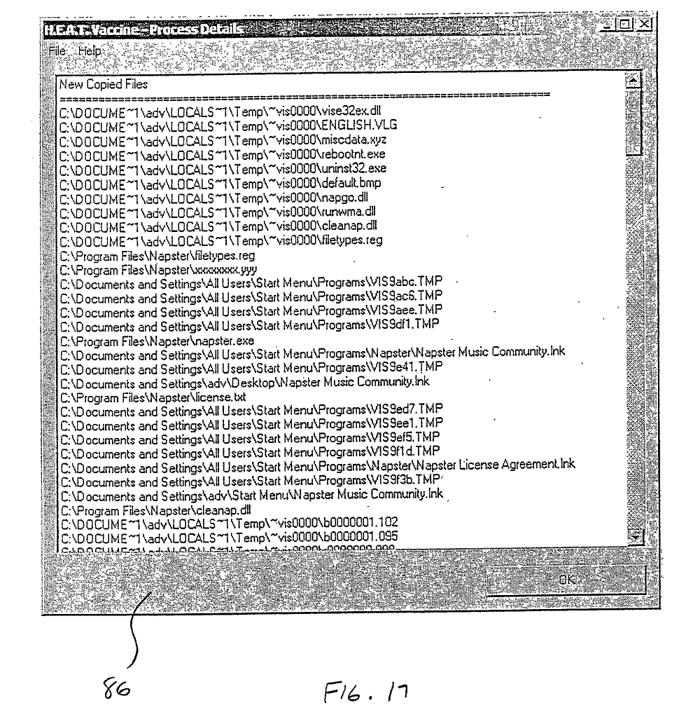

The IMP tool 40 works on executables the same as it does on scripts and effectively contains PrettyPark in both the manual and automatic modes. A record of the IMP tool's 40 dialogs in the manual mode appears in the screen snapshot 76 illustrated in FIG. 12, and the propagation warning and change log appears in the screen snapshots 78, 80 illustrated in FIGS. 13 and 14. The IMP tool 40 allows complete restoration of every change made by PrettyPark, as illustrated by screen snapshot 82 in FIG. 15.

The IMP tool 40 is also effective against benign installing programs downloaded from the Internet Explorer. False positives are the bane of proactive virus protection. However, the IMP tool's 40 automatic mode with restore capability ensures that programs can install properly without annoying dialogs. In the event a program turns out to be malicious, the IMP tool 40 can be used to restore the original data and subsequent modifications minutes, hours, days or even months later.

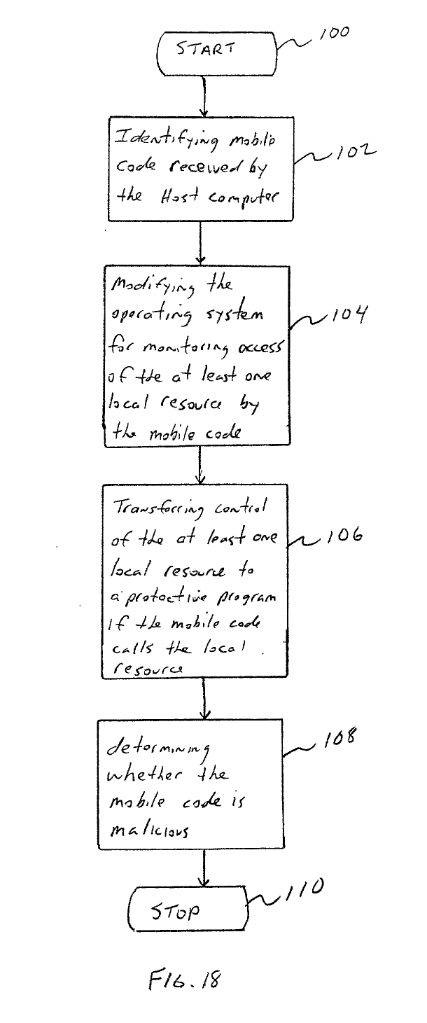

FIGS. 16 and 17 respectively show two common downloads: CdrWin is a CD burning program for Windows, and Napster is a popular music sharing application. Both install without intervention but the logs shown in screen snapshots 84 and 86 allows the IMP tool 40 to completely back them out of the host computer 30 and restore all system changes to their original, pre-installation settings.

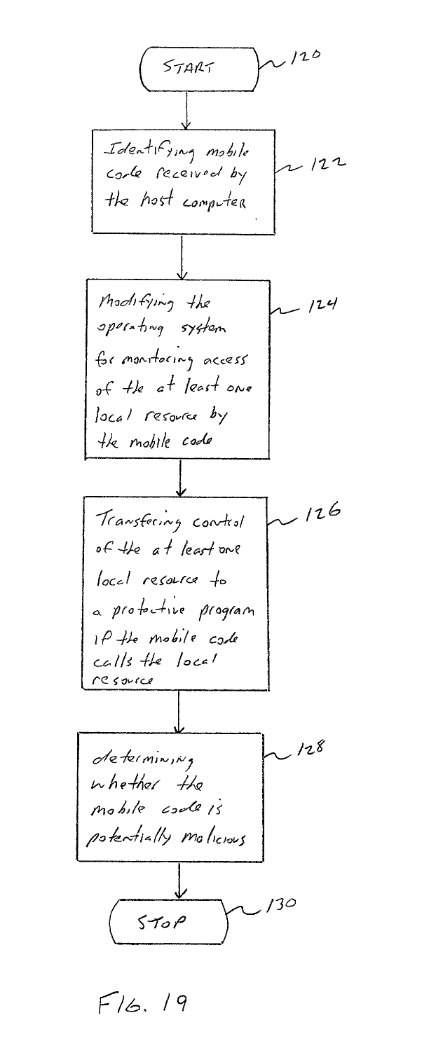

In summary, the method according to the present invention protects a host computer 30 from malicious mobile code (FIG. 18) and potentially malicious mobile code (FIG. 19), with the host computer including an operating system and at least one local resource 34 controlled thereby.

With respect to malicious mobile code, reference is directed to the flowchart illustrated in FIG. 18, and from the start (Block 100), the method comprises identifying mobile code 12 received by the host computer 30 at Block 102, and modifying the operating system 20 for monitoring access of the at least one local resource 34 by the mobile code at Block 104. Control of the at least one local resource 34 is preferably transferred to a protective program 40 if the mobile code 12 calls the at least one local resource at Block 106, and the method further comprises determining whether the mobile code is malicious at Block 108.

The method according to the present invention advantageously detects mobile code 12 at the operating system level 20, as illustrated in FIG. 1. Since detection of mobile code 12 at the application level 16 can be bypassed with native code 12b, for example, the protection program 40 of the present invention is within the operating system 20 itself waiting for the mobile code to access any of the local resources 34 within the host computer 30.

In other words, mobile code 12 is allowed to access the operating system 20 in the present invention, whereas the prior art approaches intercept the mobile code before accessing the operating system. In the present invention, to determine if the mobile code 12 calls the at least one local resource 34, the method preferably further comprises inserting at least one jump command within the operating system 20 for transferring control of the at least one local resource to the protective program 40.

The method thus further comprises transferring control of the at least one local resource 34 to the protective program via the jump command if the mobile code 12 calls the at least one local resource. Consequently, when the host computer 30 receives mobile code 12, the first statement actually executed in the operating system 20 is the jump command, which transfers control of the local resource 34 to the protective program 40. The method stops at Block 110.

With respect to potentially malicious mobile code, reference is directed to the flowchart illustrated in FIG. 19, and from the start (Block 120), the method comprises identifying mobile code 12 received by the host computer 30 at Block 122, and modifying the operating system 20 for monitoring access of the at least one local resource 34 by the mobile code at Block 124, as discussed above. Control of the at least one local resource 34 is preferably transferred to a protective program 40 if the mobile code 12 calls the at least one local resource at Block 126, and the method further comprises determining whether the mobile code is potentially malicious at Block 128.

The method may further comprise requesting user input via the display 36 before transferring control of the at least one local resource 34 back to the mobile code 12. If the user decides to execute the mobile code 12, the method may further comprise recording changes made to the host computer 30 by the mobile code. This advantageously allows the user to restore the host computer 30 to an initial condition based upon the recorded changes if the user later determines that the mobile code 12 is malicious.

Alternatively, the user may not be prompted if the mobile code 12 is potentially malicious, and control of the at least one local resource 34 is transferred back to the mobile code as above, and the changes made to the host computer 30 by the mobile code are also recorded. Likewise, if the user later determines that the potentially malicious mobile code 12 is malicious, then the user can restore the host computer 30 to an initial condition based upon the recorded changes.

Yet another aspect of this embodiment is to use a quarantine computer 31 connected to, but separate, from the host computer 30 to execute potentially malicious mobile code. The quarantine computer 31 also includes the protection program 40, but does not need to include any user data that may be lost or damaged from a malicious mobile code. The method stops at Block 130.

Another aspect of the present invention is directed to a machine readable medium having machine readable instructions stored thereon for causing a host computer 30 to perform the steps of identifying mobile code 12 received by the host computer, modifying an operating system 20 of the host computer for monitoring access of the at least one local resource 34 by the mobile code, transferring control of at least one local resource within the host computer to a protective program 40 if the mobile code calls the at least one local resource. In one embodiment, a determination is made as to whether the mobile code is malicious. In another embodiment, a determination is made as to whether the mobile code is potentially malicious.

Yet another aspect of the present invention is directed to a computer system 30 comprising a processor 32 having an operating system 20 associated therewith, at least one local resource 34 controlled by the operating system, and a memory 38 connected to the processor and having stored therein a protective program 40 as described above. In one embodiment, the protective program 40 is for protecting the at least one local resource 34 from a malicious mobile code. In another embodiment, the protective program 40 is for protecting the at least one local resource 34 from a potentially malicious mobile code.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. A method for protecting a host computer from malicious mobile code, the host computer including an operating system and at least one local resource controlled thereby, the method comprising:
identifying mobile code received by the host computer;
modifying the operating system for monitoring access of the at least one local resource by the mobile code;
transferring control of the at least one local resource to a protective program if the mobile code calls the at least one local resource; and
determining whether the mobile code is malicious.

2. A method according to claim 1, wherein modifying the operating system comprises inserting at least one jump command therein; and wherein transferring control is responsive to the jump command when the mobile code calls the at least one local resource.

3. A method according to claim 1, wherein the protective program blocks access to the at least one local resource by the mobile code if the mobile code is malicious.

4. A method according to claim 1, wherein the determining comprises comparing a function of the at least one local resource to be accessed by the mobile code to a list of prohibited functions.

5. A method according to claim 4, wherein the list of prohibited functions includes at least one of operating system functions, file functions, registry functions, library functions, communication functions and network functions.

6. A method according to claim 1, further comprising transferring control of the at least one local resource back to the mobile code if the mobile code is not malicious.

7. A method according to claim 1, further comprising determining whether the mobile code is potentially malicious, and responsive thereto requesting user input before transferring control of the at least one local resource back to the mobile code.

8. A method according to claim 7, further comprising recording changes made to the host computer if the user allows the potentially malicious mobile code to access the at least one local resource.

9. A method according to claim 8, further comprising restoring the host computer to an initial condition based upon the recorded changes if the user determines that the potentially malicious mobile code is malicious.

10. A method according to claim 1, further comprising determining whether the mobile code is potentially malicious, and responsive thereto executing the potentially malicious mobile code on a computer separate from the host computer.

11. A method according to claim 1, further comprising determining whether the mobile code is potentially malicious, and responsive thereto the method further comprises:
transferring control of the at least one local resource back to the mobile code without user input; and
recording changes made to the host computer by the mobile code.

12. A method according to claim 11, further comprising restoring changes made to the host computer if the user determines that the potentially malicious mobile code is malicious.

13. A method according to claim 2, wherein the at least one jump command is inserted responsive to the mobile code being identified.

14. A method according to claim 1, wherein the operating system operates in a Windows based environment.

15. A method for protecting a host computer from malicious mobile code, the host computer including an operating system and at least one local resource controlled thereby, the method comprising:
identifying mobile code received by the host computer;
inserting at least one jump command within the operating system for monitoring access of the at least one local resource by the mobile code;
transferring control of the at least one local resource to a protective program via the at least one jump command if the mobile code calls the at least one local resource; and
blocking access to the at least one local resource by the mobile code if the mobile code is malicious.

16. A method according to claim 15, wherein the blocking is performed in response to the protective program determining that the mobile code is malicious.

17. A method according to claim 16, wherein the determining comprises comparing a function of the at least one local resource to be accessed by the mobile code to a list of prohibited functions.

18. A method according to claim 15, further comprising transferring control of the at least one local resource back to the mobile code if the mobile code is not malicious.

19. A method according to claim 15, further comprising determining whether the mobile code is potentially malicious, and responsive thereto requesting user input before transferring control of the at least one local resource back to the mobile code.

20. A method according to claim 19, further comprising recording changes made to the host computer if the user allows the potentially malicious mobile code to access the at least one local resource.

21. A method according to claim 20, further comprising restoring the host computer to an initial condition based upon the recorded changes if the user determines that the potentially malicious mobile code is malicious.

22. A method according to claim 15, further comprising determining whether the mobile code is potentially malicious, and responsive thereto executing the potentially malicious mobile code on a computer separate from the host computer.

23. A method according to claim 15, further comprising determining whether the mobile code is potentially malicious, and responsive thereto the method further comprises:
transferring control of the at least one local resource back to the mobile code without user input; and
recording changes made to the host computer by the mobile code.

24. A method according to claim 23, further comprising restoring changes made to the host computer if the user determines that the potentially malicious mobile code is malicious.

25. A method for protecting a host computer from malicious mobile code, the host computer including an operating system and at least one local resource controlled thereby, the method comprising:
identifying mobile code received by the host computer;
monitoring access of the at least one local resource by the mobile code; and
using a protective program to determine whether the mobile code is potentially malicious, and if so, then
allowing the mobile code to access the at least one local resource, and
recording changes made to the host computer.

26. A method according to claim 25, further comprising restoring the host computer to an initial condition based upon the recorded changes if a user determines that the potentially malicious mobile code is malicious.

27. A method according to claim 25, further comprising using the protective program to determine whether the mobile code is malicious, and if so, then blocking access to the at least one local resource by the mobile code.

28. A method according to claim 27, further comprising comparing a function of the at least one local resource to be accessed by the mobile code to a list of prohibited functions.

29. A method according to claim 28, wherein the list of prohibited functions includes at least one of operating system functions, file functions, registry functions, library functions, communication functions and network functions.

30. A method according to claim 25, further comprising using the protective program to determine whether the mobile code is not malicious, and if so, then transferring control of the at least one local resource from the protective program to the mobile code.

31. A method according to claim 25, wherein the monitoring comprises modifying the operating system by inserting at least one jump command therein; and the method further comprises transferring control of the at least one local resource to the protective program responsive to the jump command if the mobile code calls the at least one local resource.

32. A method according to claim 25, further comprising requesting user input before allowing the mobile code to access the at least one local resource if the mobile code is potentially malicious.

33. A method according to claim 25, wherein the operating system operates in a Windows based environment.

34. A machine readable medium having machine readable instructions stored thereon for causing a host computer to perform the steps of:
identifying mobile code received by the host computer;
modifying an operating system of the host computer for monitoring access of the at least one local resource by the mobile code;
transferring control of at least one local resource within the host computer to a protective program if the mobile code calls the at least one local resource; and
determining whether the mobile code is malicious.

35. A machine readable medium according to claim 34, wherein modifying the operating system comprises inserting at least one jump command therein; and wherein transferring control is responsive to the jump command if the mobile code calls the at least one local resource.

36. A machine readable medium according to claim 34, wherein the protective program blocks access to the at least one local resource by the mobile code if the mobile code is malicious.

37. A machine readable medium according to claim 34, wherein the determining comprises comparing a function of the at least one local resource to be accessed by the mobile code to a list of prohibited functions.

38. A machine readable medium according to claim 34, further comprising transferring control of the at least one local resource back to the mobile code if the mobile code is not malicious.

39. A machine readable medium according to claim 34, further comprising determining whether the mobile code is potentially malicious, and responsive thereto requesting user input before transferring control of the at least one local resource back to the mobile code.

40. A machine readable medium according to claim 39, further comprising recording changes made to the host computer if the user allows the potentially malicious mobile code to access the at least one local resource.

41. A machine readable medium according to claim 40, further comprising restoring the host computer to an initial condition based upon the recorded changes if the user determines that the potentially malicious mobile code is malicious.

42. A machine readable medium according to claim 34, further comprising determining whether the mobile code is potentially malicious, and responsive thereto executing the potentially malicious mobile code on a computer separate from the host computer.

43. A machine readable medium according to claim 34, further comprising determining whether the mobile code is potentially malicious, and responsive thereto the machine readable medium further comprises:
transferring control of the at least one local resource back to the mobile code without user input; and
recording changes made to the host computer by the mobile code.

44. A machine readable medium according to claim 43, further comprising restoring changes made to the host computer if the user determines that the potentially malicious mobile code is malicious.

45. A machine readable medium having machine readable instructions stored thereon for causing a host computer to perform the steps of:
identifying mobile code received by the host computer;
monitoring access of the at least one local resource by the mobile code; and
using a protective program to determine whether the mobile code is potentially malicious, and if so, then
allowing the mobile code to access the at least one local resource, and
recording changes made to the host computer.

46. A method according to claim 45, further comprising restoring the host computer to an initial condition based upon the recorded changes if a user determines that the potentially malicious mobile code is malicious.

47. A machine readable medium according to claim 45, further comprising using the protective program to determine whether the mobile code is malicious, and if so, then blocking access to the at least one local resource by the mobile code.

48. A machine readable medium according to claim 47, further comprising comparing a function of the at least one local resource to be accessed by the mobile code to a list of prohibited functions.

49. A machine readable medium according to claim 48, wherein the list of prohibited functions includes at least one of operating system functions, file functions, registry functions, library functions, communication functions and network functions.

50. A machine readable medium according to claim 45, further comprising using the protective program to determine whether the mobile code is not malicious, and if so, then transferring control of the at least one local resource from the protective program to the mobile code.

51. A machine readable medium according to claim 45, wherein the monitoring comprise s modifying an operating system of the host computer by inserting at least one jump command therein; and the machine readable medium further comprises transferring control of the at least one local resource to the protective program responsive to the jump command if the mobile code calls the at least one local resource.

52. A machine readable medium according to claim 45, further comprising requesting user input before allowing the mobile code to access the at least one local resource if the mobile code is potentially malicious.

53. A computer system comprising:
a processor having an operating system associated therewith;
at least one local resource controlled by the operating system; and
a memory connected to said processor and having stored therein a protective program for protecting said at least one local resource from a malicious mobile code, the protective program for
identifying mobile code received by the processor,
modifying the operating system for monitoring access of the at least one local resource by the mobile code,
transferring control of said at least one local resource to the protective program if the mobile code calls the at least one local resource, and
determining whether the mobile code is malicious.

54. A computer system according to claim 53, wherein modifying the operating system comprises inserting at least one jump command therein; and wherein
transferring control is responsive to the jump command if the mobile code calls said at least one local resource.

55. A computer system according to claim 53, wherein the protective program blocks access to said at least one local resource by the mobile code if the mobile code is malicious.

56. A computer system according to claim 53, wherein the determining comprises comparing a function of said at least one local resource to be accessed by the mobile code to a list of prohibited functions.

57. A computer system according to claim 53, wherein the protective program transfers control of said at least one local resource back to the mobile code if the mobile code is not malicious.

58. A computer system according to claim 53, further comprising a display connected to said processor; and wherein if the protective program further determines that a function of said at least one local resource to be accessed by the mobile code is potentially malicious, then the protective program requests user input via said display before transferring control of said at least one local resource back to the mobile code.

59. A computer system according to claim 58, wherein the protective program further comprises recording changes made to said at least one local resource if the user allows the potentially malicious mobile code access thereto.

60. A computer system according to claim 59, wherein the protective program further restores said at least one local resource to an initial condition based upon the recorded changes if the user determines that the potentially malicious mobile code is malicious.

61. A computer system according to claim 53, wherein if the protective program further determines that a function of said at least one local resource to be accessed by the mobile code is potentially malicious, then the protective program transfers control of said at least one local resource back to the mobile code, and records changes made to said at least one local resource.

62. A computer system according to claim 61, wherein the protective program further restores said at least one local resource to an initial condition based upon the recorded changes if a user determines that the potentially malicious mobile code is malicious.

63. A computer system according to claim 53, wherein the operating system operates in a Windows based environment.

64. A computer system comprising:
a processor having an operating system associated therewith;
at least one local resource controlled by the operating system; and
a memory connected to said processor and having stored therein a protective program for protecting said at least one local resource from a malicious mobile code, the protective program for
identifying mobile code received by the processor,
monitoring access of the at least one local resource by the mobile code, and
determining whether the mobile code is potentially malicious, and if so, then
allowing the mobile code to access said at least one local resource, and
recording changes made thereto.

65. A computer system according to claim 64, wherein the protective program further restores said at least one local resource to an initial condition based upon the recorded changes if a user determines that the potentially malicious mobile code is malicious.

66. A computer system according to claim 64, further comprising using the protective program to determine whether the mobile code is malicious, and if so, then blocking access to said at least one local resource by the mobile code.

67. A computer system according to claim 66, wherein the protective program further comprises comparing a function of said at least one local resource to be accessed by the mobile code to a list of prohibited functions.

68. A computer system according to claim 64, further comprising using the protective program to determine whether the mobile code is not malicious, and if so, then transferring control of said at least one local resource from the protective program to the mobile code.

69. A computer system according to claim 64, wherein the monitoring comprises modifying the operating system by inserting at least one jump command therein; and the protective program further comprises transferring control of said at least one local resource to the protective program responsive to the jump command if the mobile code calls the at least one local resource.

70. A computer system according to claim 64, further comprising a display connected to said processor, and wherein the protective program further comprises requesting user input via said display before allowing the mobile code to access said at least one local resource if the mobile code is potentially malicious.

71. A computer system according to claim 64, wherein the operating system operates in a Windows based environment.
